(19) United States
(12) Patent Application Publication
(10) Pub. No.: US 2009/0187978 A1
(43) Pub. Date: Jul. 23, 2009

(54) SECURITY AND AUTHENTICATIONS IN PEER-TO-PEER NETWORKS

(75) Inventors: Manish Upendran, San Jose, CA (US); Scott Renfro, San Jose, CA (US); Saurabh Tewari, Sunnyvale, CA (US); Bhargavaram B. Gade, Richardson, TX (US); Satish Menon, Sunnyvale, CA (US); Tanvi Vyas, Mountain View, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 12/016,582

(22) Filed: Jan. 18, 2008

(51) Int. Cl. G06F 21/00

(52) U.S. Cl. 726/5

(57) ABSTRACT

A system and method for providing access to a secured data resource to a client on a peer-to-peer network. The system includes a content management server which receives and verifies a first request for access to a secured data resource from the client. If the first request is valid, the content management server generates a second request for access to the secured data resource which comprises peer-to-peer control information and information identifying the secured data resource, and which can additionally include a signature generated using a shared key. The content management transmits the second request to the client, which then retransmits the second request to a peer-to-peer control server. The control server receives the second request and validates it. Such validations can include validating the request with the shared key. If the second request is valid, the control server transmits instructions for accessing the secured data resource back to the client.

### RELATED APPLICATIONS

This application claims the benefit of U.S. Provisional Application No. 60/______ ______, 2007, which application is hereby incorporated herein by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### BACKGROUND OF THE INVENTION

Peer-to-Peer networks, while highly efficient in its ability to utilize resources of network clients, also have significant security issues that limit the use of such networks for many transactions. For example, any client can masquerade as part of a peer-to-peer network using simple spoofing techniques. Such a client can be further able extract identities of other users in the network by examining control information such as, for example, joins and leaves by other peers in the network. Ultimately, such a client can be able to participate in conversations that that are ordinarily forbidden to unauthorized participants or to gain access to content reserved for subscribers.

### SUMMARY OF THE INVENTION

In one embodiment, the invention is a system and method for a content management server to enable a client on a peer-to-peer network to obtain access to a secured data resource. The content management server receives a first request for access to the secured data resource from the client and verifies the client is authorized to obtain access to the secured data resource. If the client is authorized to access the secured data resource, the content management server generates a second request for access to the secured data resource. The second request comprises peer-to-peer control information and information identifying the secured data resource. The content management server then transmits the second request back to the client.

In another embodiment, the invention is a system and method for a control server which provides control services to at least a portion of a peer-to-peer network to manage access to a secured data resource. The control server receives a request from a client on the peer-to-peer network for access to the secured data resource. The request comprises peer-to-peer control information and information identifying the secured data resource. The control server validates the request, and, if the request is valid, generates instructions for accessing the secured data resource and transmits the instructions to the client.

In another embodiment, the invention is a system and method for a client on a peer-to-peer network which is managed by a control server to obtain access to a secured data resource. The client transmits a first request for access to the secured data resource to a content management server. The first request includes a first set of validation credentials. In response to the transmitted request, the client receives a second request for access to the secured data resource from the content management server. The request comprises peer-to-peer control information, information identifying the secured data resource, and a second set of validation credentials. The client then transmits the second request to the control server, and in return, receives instructions for accessing the secured data resource from the control server.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of at least one embodiment of the invention.

FIG. 1 is a high-level illustration of an embodiment of an architecture suitable for practicing embodiments of the present invention.

FIG. 2 is a high-level flow chart of one embodiment of a method for secure stream transmission.

FIG. 3 is an illustration of one embodiment of a method that can be employed by a peer-to-peer control server to validate an incoming peer-to-peer streaming request.

FIG. 4 illustrates one embodiment of the modules comprising a content management server.

FIG. 5 illustrates one embodiment of the modules comprising a peer-to-peer control server

FIG. 6 illustrates one embodiment of the modules comprising a peer-to-peer client.

### DETAILED DESCRIPTION OF EMBODIMENTS OF THE INVENTION

The present invention is described below with reference to block diagrams and operational illustrations of methods and devices to store and/or access information regarding medical billing information. It is understood that each block of the block diagrams or operational illustrations, and combinations of blocks in the block diagrams or operational illustrations, can be implemented by means of analog or digital hardware and computer program instructions.

These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure the term “media” and “media content” should be understood to refer to binary data which contains content which can be interest to an end user. By way of example, and not limitation, the term “media” and “media content” can refer to multimedia data, such as video data or audio data, or any other form of data capable of being transformed into a form perceivable by an end user. Such data can, furthermore, be encoded in any manner currently known, or which can be developed in the future, for specific purposes. By way of example, and not limitation, the data can be further encrypted, compressed, and/or can contained embedded metadata.

For the purposes of this disclosure the term “stream” and “data stream” should be understood to refer to a stream of binary data between a data source and a data consumer. The data can be consumed as it is received by the data consumer (i.e. “real-time” or “near time”, or can be stored for later consumption. The stream can be continuous, or subject to period interruption. By way of example, and not limitation, the term “stream” and “data stream” can refer to a stream of media content, such as music, video, or audio video data. Such data can, furthermore, be encoded in any manner currently known, or which can be developed in the future, for specific purposes. By way of example, and not limitation, the data can be encrypted, compressed, and/or can contained embedded metadata.

For the purposes of this disclosure a computer readable medium stores computer data in machine readable form. By way of example, and not limitation, a computer readable medium can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules.

Reference will now be made in detail to illustrative embodiments of the present invention, examples of which are shown in the accompanying drawings.

The embodiments discussed below generally relate to hybrid peer-to-peer networks which provide improved security by separating a decentralized data plane from a more centralized control plane. In such an architecture, the centralized control servers act as mediators and create secure control channels by using a variety of mechanisms.

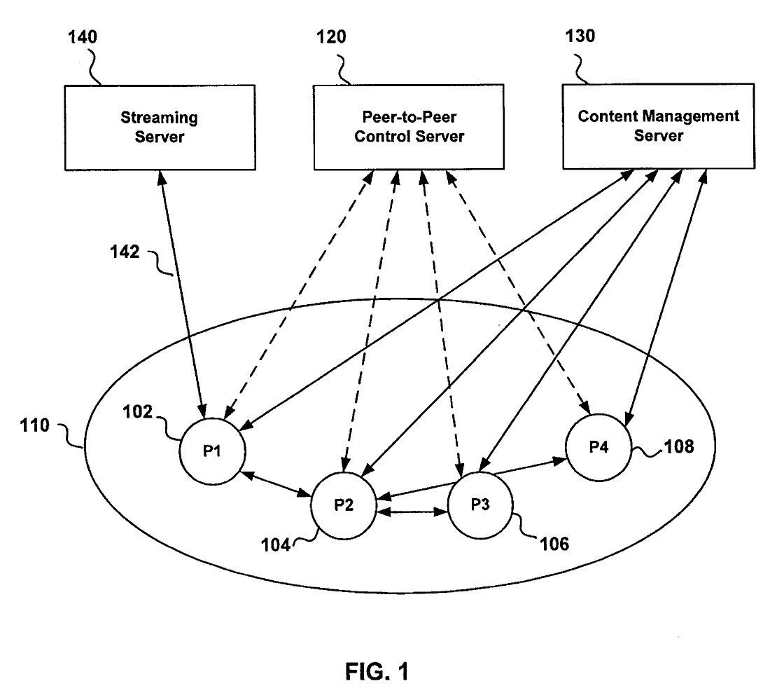

FIG. 1 is a high-level illustration of an embodiment of an architecture 100 suitable for practicing embodiments of the present invention. The architecture 100 is comprised of four peer-to-peer clients 102, 104, 106, and 108 organized into a peer-to-peer network 110. All clients have network connectivity to a peer-to-peer control server 120 and a content management server 130. Client 102 is actively connected to a streaming server 140 for the purpose of receiving a secured data resource, for example a media stream 142. Client 102 is connected to client 104 and can retransmit the data stream 142 to client 104. Client 104 is further connected to clients 106 and 108 and can retransmit any data streams received by it to clients 106 and 108.

The peer-to-peer control server 120 provides control services for the peer-to-peer network. For example, without limitation, the control server 120 can have the capacity to establish, tear down and modify peer connections both at run time and on demand within the peer-to-peer network. Any given client that joins the network can be required to register with the control server 120. When a client makes a request for a stream, the control server 120 can verify the authenticity of the request and determine which clients on the network have the capability to stream to the requesting client. The peer-to-peer control server 120 can connect with peer-to-peer clients over an external network, for example, the Internet, or over any other available network which is capable of providing connectivity between the server and the clients.

The content management server 130 provides content management services for clients within the peer-to-peer network. Such services can include indexing and cataloging of content, such as media, which can be available to clients. Such services can additionally include authenticating incoming requests for access to secured data for account specific information which can include validation of a user ID associated with a client request, the user ID's subscription level, any geographical restrictions that can restrict content accessible to the user ID, and whether the user has permission to stream etc. The content management server 130 can additionally transform requests to stream URLs including appending various pieces of session specific information to the URL such as, for example, session ID, timestamps, and so forth. The content management server 130 can connect with peer-to-peer clients over an external network, for example, the Internet, or over any other available network which is capable of providing connectivity between the server and the clients.

The streaming server 140 provides streaming media to clients within the peer-to-peer network. Such streaming media can include audio or video content such as, without limitation, music, music videos, movies, television shows, and live broadcasts, such as NFL games. The streaming server 140 can additionally, or alternatively, provide static files, such as static image files or text files. Clients receiving streaming media can consume the media immediately, or cache it for later use. The streaming server 140 can connect with peer-to-peer clients over an external network, for example, the Internet, or over any other available network which is capable of providing connectivity between the server and the clients.

The peer-to-peer control server 120, the content management server 130, and the streaming server 140 can be implemented as three physically separate servers, and can additionally be provided by or administered by three independent organizations. Alternatively, two or more of the servers 120, 130, and 140 can be consolidated in a single server, or the system can contain multiple control servers or content management servers. The system can further provide for multiple streaming servers 140, where individual servers can mirror one another, or can provide entirely different content.

The peer-to-peer clients 102, 104, 106, and 108 can be implemented using commercially available peer-to-peer client software and can be implemented on any hardware platform capable of supporting such software. For example, hardware platforms capable of supporting peer-to-peer client software can include, without limitation, personal computers, cellular telephones, or personal digital assistants. The peer-to-peer clients can connect with one another over an external network, for example, the Internet, or over any other available network which is capable of providing connectivity between the clients. Four clients are shown for the purposes of this example, however, one skilled in the art will recognize that any number of clients can be supported by the systems and methods described herein.

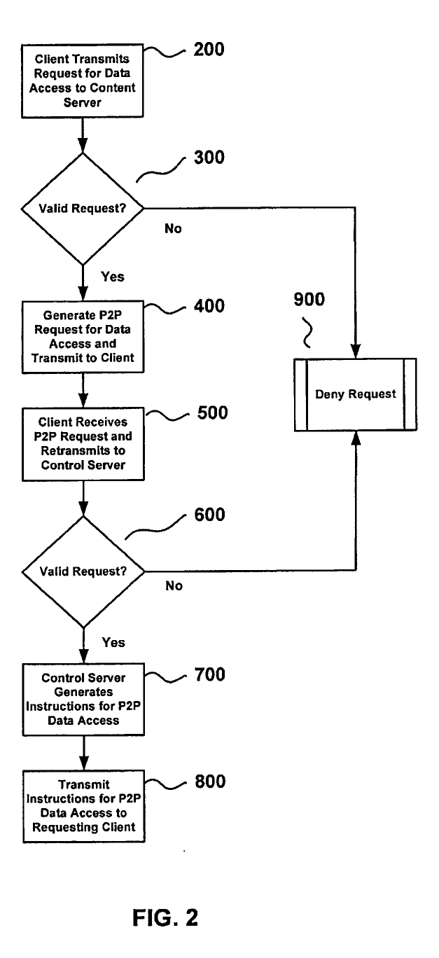

FIG. 2 is a high-level flow chart of one embodiment of a method for secure stream transmission which can be implemented, for example, using the using the architecture illustrated in FIG. 1. In step 200, a client within a peer-to-peer transmits a request for a secured data resource to a content server. The secured data resource can be a real-time media stream, such as, without limitation an audio or video broadcast of a live event, a stored audio or video clip, or a static image file.

In step 300, the content server validates the request. If the request is not valid, it is denied 900. The validations performed by the content serve can be specific to the content provider. The content server can require, for example, that the request include a security ticket which can be time limited or can specific to an individual subscriber or secured data resource. The content server additionally requires, for example, that a request for a specific data resource originate from a limited geographical area. Access to categories of secured data resources can be further limited to categories of subscribers, such as premium subscribers.

If the request for a secured data resource is valid, in step 400, the content server generates a second request for access to the secured data resource and transmits the second request to the requesting client. The second request can contain information regarding the location of the secured data resource and peer-to-peer connection information. The second request can be signed using signature generated using request specific information and a key which can be shared with other elements of the network.

In step 500, the second request for access to the secured data resource is transmitted to the control server. In step 600, the control server validates the second request. If the request is not valid, it is denied 900. If the request is valid, in step 700 the control server generates instructions for accessing the secured data resource, and transmits the instructions back to the requesting client. In step 800, the requesting client receives the instructions to access the secured data resource from the control server, which it can then use to access the data, for example, by connecting directly to a streaming server or by connecting to another client within the same peer-to-peer network.

The request for access to a secured data resource transmitted to the content server by the requesting client in step 200 of FIG. 2 can be formatted according to the proprietary requirements of the content management server. For example, the request can be formatted:

/makeplaylist.dll?ticket=3f2ac584c826a7d593ac2ce15302b8ab&sid=
38977134&t=wmv&br=500&s=791022595&so=%2FMUSIC&xdata=
NjgzNjY3MDYxNDZmYWYzNT-

Where: ticket—An authentication ticket required to access the requested stream.

sid—A stream ID which identifies a requested media stream.

t—The type of the file.

br—bit rate requested, and so forth.

The second request for access to a secured data resource generated by the content server in step 400 of FIG. 2 can be constructed based on the requirements of the peer-to-peer protocol being used and additionally include peer-to-peer parameters specifically regarding the secured data resource. The request can be formatted as a peer-to-peer URL with parameters specifically regarding the secured data resource appended to the URL. For example, the request can be formatted:

/<peer to peer proprietary streaming url>?u=VOC4pqrQRK/-
&t=1192237374&c=7233191742&s=oUVfo4.1UrUxbXqRt93Qgw--

Where: u—An opaque but unique and long-lived identifier.

t—A timestamp at the time the request was signed.

c—The channel id of the content to be delivered.

s—The signature of all the proceeding components.

In one embodiment, ‘c’ the channel ID is required and identifies the secured data resource to be delivered to the requesting client. The channel ID can reflect, for example, a stream ID requested by the client and can additionally reflect the client's request parameters, such as file type and bit rate.

In one embodiment, “u” is optional. When present, it instructs the server to revoke any existing streams for this same channel id (“c”) and unique identifier (“u”) that can be active before delivering a new stream as a result of this request. This effectively implements a “one-user-one-stream” rule.

In one embodiment, “t” is optional. When present, the parameter can instruct the server to honor the request when (t+xx seconds)<current time. If “t” is too far in the past, then an error can be returned to the client. The parameter can be represented as the Unix time (i.e., seconds since 1970-01-01) in ASCII decimal. The timeout period can be configurable based on content requirements.

In one embodiment, the signature is required. The signature can be computed using any technique known in the art. For example, the signature can be computed by concatenating key=value pairs delimited by “&” in the order they appear in the request with a shared key followed by hashing the resulting string with MD5 and encoding the result in base64. Following encoding, three character substitutions can be applied to allow the result to be included in a URL: “=”→“−”,“+”→“.”, and “/”→“ ”.

Parameters within the peer-to-peer URL can be a variable number and greatly extensible within the constraints of the http protocol, based on the streaming requirements. For example, a provider could validate a request based on geographical coordinates. For example, the request can be formatted:

/<peer to peer proprietary streaming
url>?u=12AedFd4523DS&t=113435343&c=730780347&lat=
236&lon=432&s=UVFO4.LUxf434234.9345--

Where: u—An opaque but unique and long-lived identifier.

t—A timestamp at the time the request was signed.

c—The channel id of the content to be delivered.

lat—Latitude.

lon—Longitude.

s=signature(u&t&c&lat&lon,shared key).

In one embodiment, geographic restrictions may to selected user or can be content dependant.

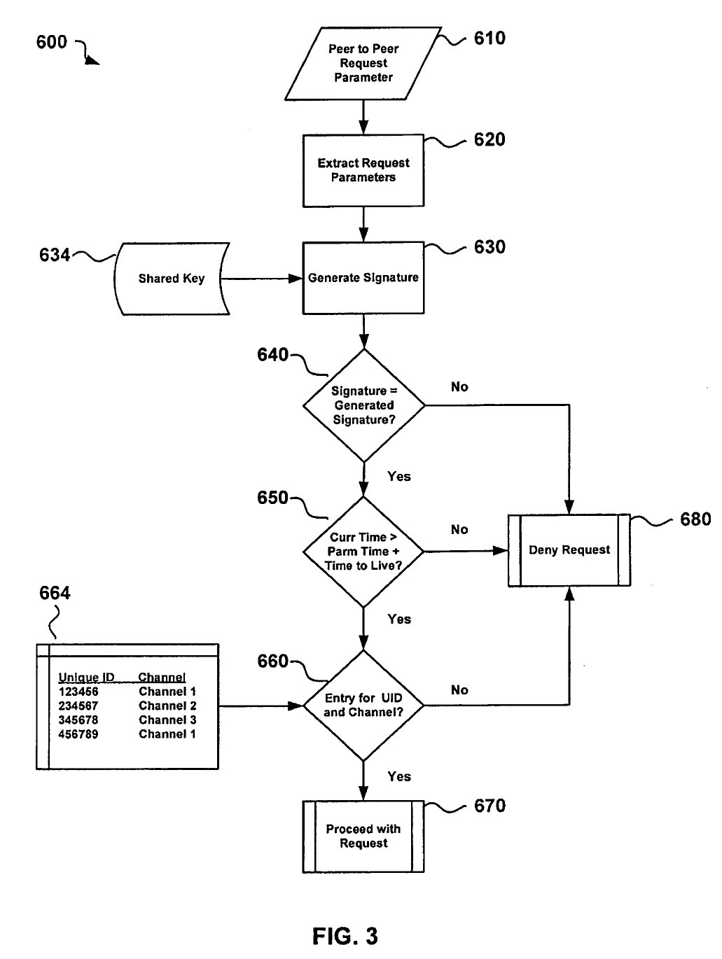

FIG. 3 illustrates one embodiment of a method 600 that can be employed by a peer-to-peer control server to validate an incoming peer-to-peer streaming request. In step 610, the peer-to-peer streaming request is received. One example of such a request can the example presented above in paragraph [0032]:

/<peer to peer proprietary streaming url>?u=VOC4pqrQRK/-
&t=1192237374&c=7233191742&s=oUVfo4.1UrUxbXqRt93Qgw--

In step 620, request parameters are extracted. In the example presented above, the results of such an extraction operation can yield:

Unique identifier=VOC4pqrQRK/-

Time of request (t)=1192237374

Channel ID (c)=7233191742

Signature (s)=UVfo4.1UrUxbXqRt93Qgw--

In step 630, a signature is generated for the peer-to-peer streaming request using the extracted request parameters and a key 634 shared with the source of the peer-to-peer streaming request such as a content management server. In step 640, the computed signature is compared to the signature extracted from the request parameters. If the computed signature does not match the signature extracted from the request parameters, the request can have been altered by an unauthorized user, and the request is denied 680.

In step 650, the time of the request is incremented by a predetermined time interval and compared to the current time. If the computed time is greater than the current time, the request has expired and is denied 680. The predetermined time interval can be system wide, or can be specific to a category of data (i.e. streaming video vs. streaming audio), a category of users (i.e. premium vs. non-premium), or any other category of relevance.

In step 660, the unique identifier and channel ID can be used to query a database table 664 containing entries for all active unique identifiers on the peer-to-peer network and all channels for stream requests issued using a specific unique identifier. If a unique identifier has already used to make a stream request for a specific channel ID, the request can be denied 680. If there are no outstanding requests for access to a specific stream ID associated with the unique identifier, the request can be allowed 670. Additional validations can be employed based on a specific provider's needs. For example, a specific unique identifier can additionally be limited to accessing one stream at a time.

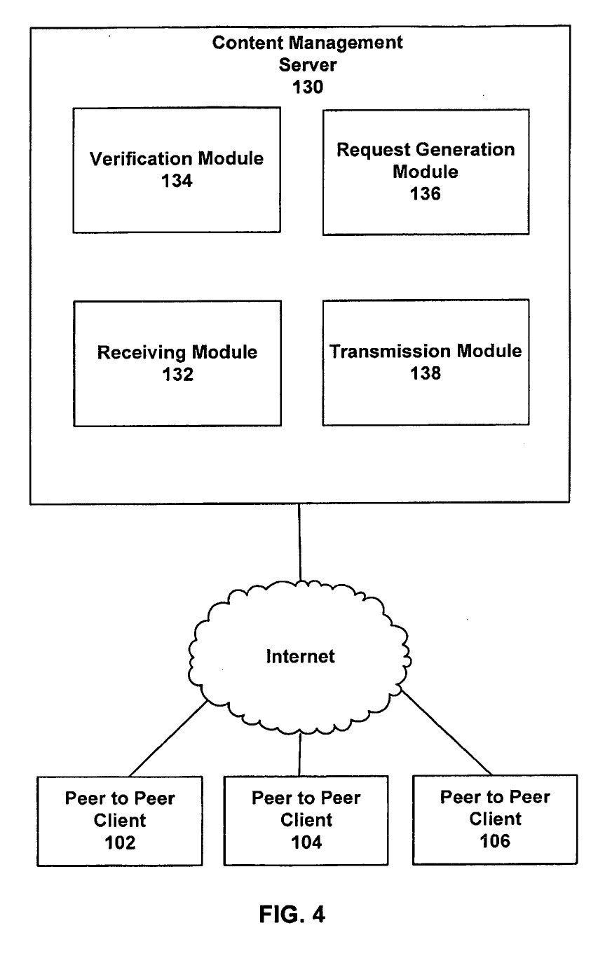

FIG. 4 illustrates one embodiment of a content management server 130 capable of carrying out the methods disclosed above. The content management server 130 is accessible to peer-to-peer clients 102, 104, and 106 through an external network, for example, the Internet. A receiving 132 module receives requests for access to a secured data resource from clients on a peer-to-peer network. After a request has been received, a verification module 134 verifies that the client is authorized to obtain access to the secured data resource.

After a request has been verified, a request generation module 136 generates a second request for access to the secured data resource. The request comprises peer-to-peer control information and information identifying the secured data resource, and may additionally comprise additional security parameters. Additional security parameters can include a signature. In one embodiment, the request generation module 136 can generate the signature using at least a portion of the information identifying the secured data resource and a key shared with a peer-to-peer control server. Additional security parameters can also include a timestamp and a unique identifier. After the second request is generated, a transmission module 138 transmits the second request to the requesting client.

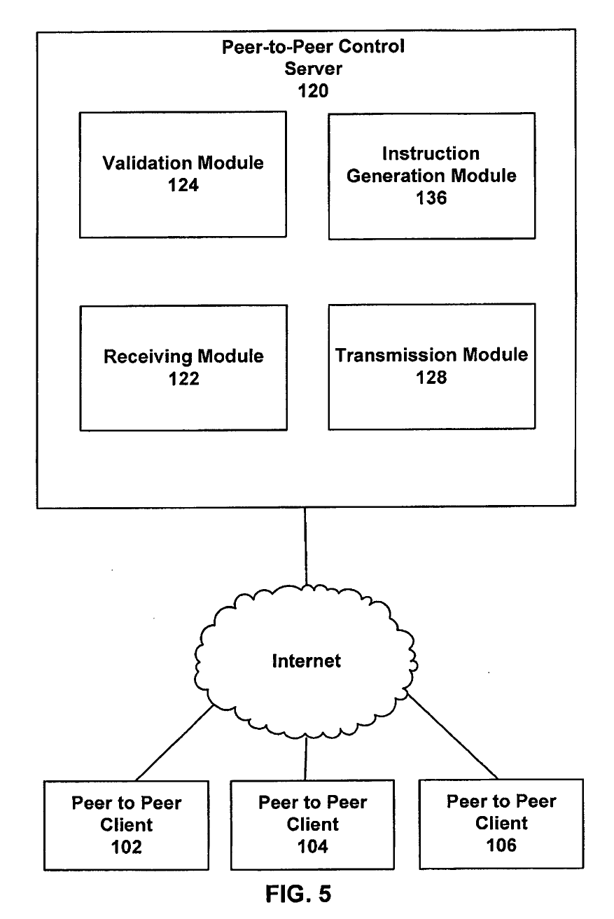

FIG. 5 illustrates one embodiment of a peer-to-peer control server 120 capable of carrying out the methods disclosed above. The peer-to-peer control server 120 is accessible to peer-to-peer clients 102, 104, and 106 through an external network, for example, the Internet. A receiving module 122 receives request from peer-to-peer clients for access to a secured data resource. The request includes peer-to-peer control information and information identifying the secured data resource and can include additional security parameters. Additional security parameters can include a signature, a timestamp, and a unique identifier.

After a request is received, a validation module 124 validates the request. If the request includes a signature, the validation module 124 may use the signature to validate the request. In one embodiment, the request is validated by generating a second signature using at least a portion of the information identifying the secured data resource and a key shared with a content management server and comparing the signature on the request to the second signature. If the request includes a timestamp, the validation module 124 may use the timestamp to validate the request. In one embodiment, the timestamp is validated by determining if the timestamp plus a predetermined time interval is less than the current time. If the request includes a unique identifier, the validation module 124 may use the unique identifier to validate the request. In one embodiment, the request is validated by determining that no request associated with the unique identifier is pending for the secured data resource.

After the request has been validated, an instruction generation module 126 generates instructions for accessing the secured data resource. After instructions for accessing the secured data resource have been generated, a transmission module 128 transmits the instructions to the requesting client.

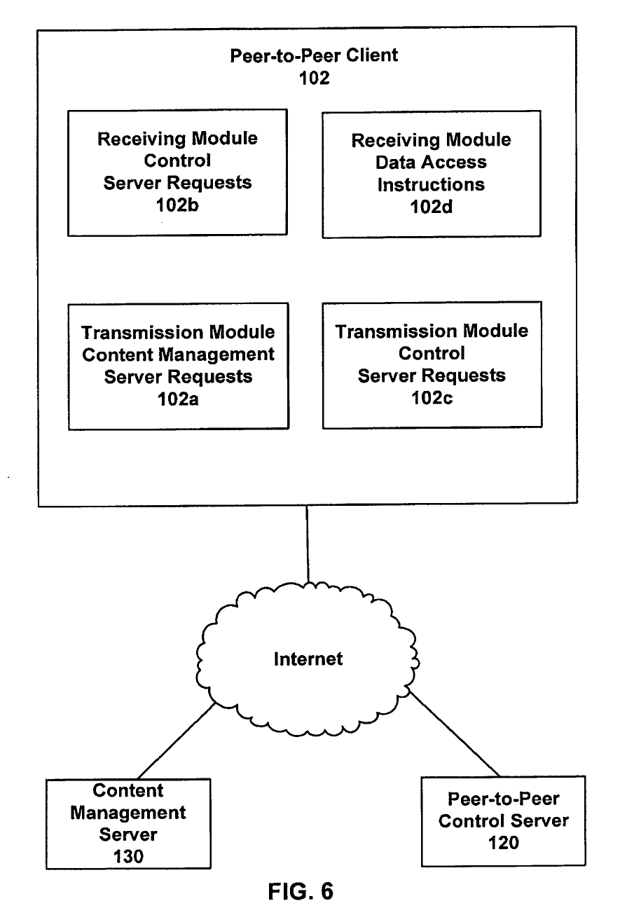

FIG. 6 illustrates one embodiment of a peer-to-peer client 102 capable of carrying out the methods disclosed above. The peer-to-peer client 102 has access to a content management server 130 and a peer-to-peer control server 120 through an external network, for example, the Internet. A transmission module 102a transmits requests for access to secured data resources to the content management server 130. The requests include a set of validation credentials which may include a User ID or a cookie.

A receiving module 102b receives requests for access to the secured data resource from the content management server 130. The requests received from the content management server 130 include peer-to-peer control information, information identifying the secured data resource, and a set of validation credentials. The validation credentials on the requests received from the content management server 130 can include a unique identifier and a signature. In one embodiment, the signature was generated by the content management server using at least a portion of the information identifying the secured data resource and a key shared by the content management server.

Requests for access to secured data resources received from the content management server 130 are transmitted by a transmission module 102c to the peer-to-peer control server 120. A receiving module 102d receives instructions for accessing secured data resources from the peer-to-peer control server 120.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

We claim:

1. A method comprising the steps:
receiving a first request for access to a secured data resource from a client on a peer-to-peer network,
verifying that the client is authorized to obtain access to the secured data resource;
generating a second request for access to the secured data resource, wherein the request comprises peer-to-peer control information and information identifying the secured data resource; and
transmitting the second request to the client.

2. The method of claim 1 wherein the second request additionally comprises a signature.

3. The method of claim 2 wherein the signature is generated using at least a portion of the information identifying the secured data resource and a key.

4. The method of claim 3 wherein the key is shared with a control server which provides control services to at least a portion of the peer-to-peer network.

5. The method of claim 1 wherein the second request additionally comprises a timestamp.

6. The method of claim 1 wherein the second request additionally comprises a unique identifier.

7. The method of claim 1 wherein the second request comprises a URL, the URL containing one to n request parameters, and being formatted as follows:
/<peer to peer proprietary streaming url>?p1=(value)&p2=(value)... &pn=(value)
wherein p1 through pn are request parameters, and wherein at least one parameter identifies the secured data resource.

8. The method of claim 7 wherein the second request comprises at least four request parameters, wherein p equals:
u—a unique identifier,
t—a timestamp,
c—the channel id of the content to be delivered, and
s—the signature of all the proceeding components.

9. The method of claim 8 wherein the second request comprises at least two additional request parameters, wherein p equals:
lat—latitude, and
lon—longitude.

10. A method for a comprising the steps:
receiving a request from a client on a peer-to-peer network for access to a secured data resource, the request comprising peer-to-peer control information and information identifying the secured data resource;
validating the request;
generating instructions for accessing the secured data resource; and
transmitting the instructions to the client.

11. The method of claim 10 wherein the request additionally comprises a first signature and wherein the signature is used to validate the request.

12. The method of claim 11 wherein the request is validated using the first signature by generating a second signature using at least a portion of the information identifying the secured data resource and a key and comparing the first signature to the second signature.

13. The method of claim 12 wherein the key is shared with a content management server which manages access to the secured data resource.

14. The method of claim 10 wherein the request additionally comprises a timestamp and wherein the timestamp is used to validate the request.

15. The method of claim 14 wherein request is validated using the timestamp by determining if the timestamp plus a predetermined time interval is less than the current time.

16. The method of claim 10 wherein the request additionally comprises a unique identifier and wherein the unique identifier is used to validate the request.

17. The method of claim 16 wherein the request is validated using the unique identifier by determining that no request associated with the unique identifier is pending for the secured data resource.

18. A method comprising the steps:
transmitting a first request for access to the secured data resource to a content management server, the first request additionally comprising a first set of validation credentials;
receiving a second request for access to the secured data resource from the content management server, the request comprising peer-to-peer control information, information identifying the secured data resource, and a second set of validation credentials;
transmitting the second request to a peer-to-peer control server;
receiving instructions for accessing the secured data resource from the peer-to-peer control server.

19. The method of claim 18 wherein the first set of validation credentials contains at least one item selected from the list: User ID, cookie.

20. The method of claim 18 wherein the second set of validation credentials contains at least one item selected from the list: unique identifier, signature.

21. The method of claim 20 wherein the signature is generated using at least a portion of the information identifying the secured data resource and a key.

22. The method of claim 21 wherein the key is known to the control server and the content management server.

23. A computer-readable medium having computer-executable instructions for a method comprising the steps:
receiving a first request for access to a secured data resource from a client on a peer-to-peer network;
verifying that the client is authorized to obtain access to the secured data resource;
generating a second request for access to the secured data resource, wherein the request comprises peer-to-peer control information and information identifying the secured data resource; and
transmitting the second request to the client.

24. The computer-readable medium of claim 23 wherein the second request additionally comprises a signature.

25. The computer-readable medium of claim 24 wherein the signature is generated using at least a portion of the information identifying the secured data resource and a key.

26. The computer-readable medium of claim 25 wherein the key is shared with a control server which provides control services to at least a portion of the peer-to-peer network.

27. The computer-readable medium of claim 23 wherein the second request additionally comprises a timestamp.

28. The computer-readable medium of claim 23 wherein the second request additionally comprises a unique identifier.

29. The computer-readable medium of claim 23 wherein the second request comprises a URL, the URL containing one to n request parameters, and being formatted as follows:
/<peer to peer proprietary streaming url>?p1=(value)&p2=(value)... &pn=(value)
wherein p1 through pn are request parameters, and wherein at least one parameter identifies the secured data resource.

30. The computer-readable medium of claim 23 wherein the second request comprises at least four request parameters, wherein p equals:
u—a unique identifier,
t—a timestamp,
c—the channel id of the content to be delivered, and
s—the signature of all the proceeding components.

31. The computer-readable medium of claim 30 wherein the request comprises at least two additional request parameters, wherein p equals:
lat—latitude, and
lon—longitude.

32. A computer-readable medium having computer-executable instructions for a method comprising the steps:
receiving a request from a client on the peer-to-peer network for access to a secured data resource, the request comprising peer-to-peer control information and information identifying the secured data resource;
validating the request;
generating instructions for accessing the secured data resource; and
transmitting the instructions to the client.

33. The computer-readable medium of claim 32 wherein the request additionally comprises a first signature and wherein the first signature is used to validate the request.

34. The computer-readable medium of claim 33 wherein the request is validated using the first signature by generating a second signature using at least a portion of the information identifying the secured data resource and a key and comparing the first signature to the second signature.

35. The computer-readable medium of claim 34 wherein the key is shared with a content management server which manages access to the secured data resource.

36. The computer-readable medium of claim 34 wherein the request additionally comprises a timestamp and wherein the timestamp is used to validate the request.

37. The computer-readable medium of claim 36 wherein request is validated using the timestamp by determining if the timestamp plus a predetermined time interval is less than the current time.

38. The computer-readable medium of claim 33 wherein the request additionally comprises a unique identifier and wherein the unique identifier is used to validate the request.

39. The computer-readable medium of claim 38 wherein the request is validated using the unique identifier by determining that no request associated with the unique identifier is pending for the secured data resource.

40. A computer-readable medium having computer-executable instructions for a method comprising the steps:
transmitting a first request for access to the secured data resource to a content management server, the first request additionally comprising a first set of validation credentials;
receiving a second request for access to the secured data resource from the content management server, the request comprising peer-to-peer control information, information identifying the secured data resource, and a second set of validation credentials;
transmitting the second request to a peer-to-peer control server;
receiving instructions for accessing the secured data resource from the peer-to-peer control server.

41. The method of claim 40 wherein the first set of validation credentials contains at least one item selected from the list: User ID, cookie.

42. The method of claim 40 wherein the second set of validation credentials contains at least one item selected from the list: unique identifier, signature.

43. The computer-readable medium of claim 42 wherein the signature is generated using at least a portion of the information identifying the secured data resource and a key.

44. The computer-readable medium of claim 43 wherein the key is known to the control server and the content management server.

45. A system comprising:
a receiving module that receives a first request for access to a secured data resource from a client on a peer-to-peer network;
a verification module that verifies that the client is authorized to obtain access to the secured data resource;
a request generation module that generates a second request for access to the secured data resource, wherein the request comprises peer-to-peer control information and information identifying the secured data resource; and
a transmission module that transmits the second request to the client.

46. The system of claim 45 wherein the second request generated by the request module additionally comprises a signature.

47. The system of claim 46 wherein the signature is generated by the request generation module using at least a portion of the information identifying the secured data resource and a key.

48. The system of claim 47 wherein the key is shared with a control server which provides control services to at least a portion of the peer-to-peer network.

49. The system of claim 45 wherein the second request generated by the request generation module additionally comprises a timestamp.

50. The system of claim 45 wherein the second request generated by the request generation module additionally comprises a unique identifier.

51. The system of claim 45 wherein the second request generated by the request generation module comprises a URL, the URL containing one to n request parameters, and being formatted as follows:
/<peer to peer proprietary streaming url>?p1=(value)&p2=(value)... &pn=(value)
wherein p1 through pn are request parameters, and wherein at least one parameter identifies the secured data resource.

52. The system of claim 51 wherein the second request generated by the request generation module comprises at least four request parameters, wherein p equals:
u—a unique identifier,
t—a timestamp,
c—the channel id of the content to be delivered, and
s—the signature of all the proceeding components.

53. The system of claim 52 wherein the request comprises at least two additional request parameters, wherein p equals:
lat—latitude, and
lon—longitude.

54. A system comprising:
a receiving module that receives a request from a client on a peer-to-peer network for access to a secured data resource, the request comprising peer-to-peer control information and information identifying the secured data resource;
a validation module that validates the request;
an instruction generation module that generates instructions for accessing the secured data resource; and
a transmission module that transmits the instructions to the client.

55. The system of claim 54 wherein the request additionally comprises a first signature and wherein the signature is used by the validation module to validate the request.

56. The system of claim 55 wherein the request is validated by the validation module using the first signature by generating a second signature using at least a portion of the information identifying the secured data resource and a key and comparing the first signature to the second signature.

57. The system of claim 56 wherein the key is shared with a content management server which manages access to the secured data resource.

58. The system of claim 54 wherein the request additionally comprises a timestamp and wherein the timestamp is used to validate the request.

59. The system of claim 58 wherein request is validated by the validation module using the timestamp by determining if the timestamp plus a predetermined time interval is less than the current time.

60. The system of claim 59 wherein the request additionally comprises a unique identifier and wherein the unique identifier is used to by the validation module to validate the request.

61. The system of claim 60 wherein request is validated by the validation module using the unique identifier by determining that no request associated with the unique identifier is pending for the secured data resource.

62. A peer-to-peer client comprising:
a first transmission module that transmits a first request for access to the secured data resource to a content management server, the first request additionally comprising a first set of validation credentials;
a first receiving module that receives a second request for access to the secured data resource from the content management server, the request comprising peer-to-peer control information, information identifying the secured data resource, and a second set of validation credentials;
a second transmission module that transmits the second request to a peer-to-peer control server;
a second receiving module that receives instructions for accessing the secured data resource from the control server.

63. The client of 62 wherein the first set of validation credentials contains at least one item selected from the list: User ID, cookie.

64. The method of claim 63 wherein the second set of validation credentials contains at least one item selected from the list: unique identifier, signature.

65. The client of claim 64 wherein the signature was generated by the content management server the using at least a portion of the information identifying the secured data resource and a key.

66. The client of claim 65 wherein the key is known to the control server and the content management server.
